(19) United States
(12) Patent Application Publication
(10) Pub. No.: US 2025/0074311 A1
(43) Pub. Date: Mar. 6, 2025

(54) VEHICULAR DRIVER MONITORING SYSTEM WITH DISPLAY CONTROL

(71) Applicant: Magna Mirrors of America, Inc., Holland, MI (US)

(72) Inventors: Justin E. Sobecki, Rockford, MI (US); Rudy A. Morey, Hudsonville, MI (US)

(21) Appl. No.: 18/817,420

(22) Filed: Aug. 28, 2024

Related U.S. Application Data
(60) Provisional application No. 63/656,731, filed on Jun. 6, 2024.
(60) Provisional application No. 63/588,347, filed on Oct. 6, 2023.
(60) Provisional application No. 63/579,987, filed on Sep. 1, 2023.

(51) Int. Cl. B60R 1/26; B60Q 3/60; B60Q 3/70; B60R 1/04; B60R 1/12; G06F 3/01; G06V 20/59; G09G 5/10; H04N 23/695; H05B 47/11; H05B 47/125

(52) U.S. Cl. CPC B60R 1/26; B60Q 3/60; B60Q 3/70; B60R 1/04; B60R 1/12; G06F 3/013; G06V 20/597; G09G 5/10; H04N 23/695; H05B 47/11; H05B 47/125; B60R 2001/1215; B60R 2001/1253; B60R 2300/10; B60R 2300/20; G09G 2320/0626; G09G 2354/00; G09G 2360/144; G09G 2380/10

(57) ABSTRACT

A vehicular driver monitoring system includes an interior rearview mirror assembly including a mirror head that accommodates a mirror reflective element, a video display screen, and a driver monitoring camera that views at least a driver's head region of the cabin of the vehicle. The vehicular driver monitoring system, based at least in part on processing of image data captured by the driver monitoring camera, determines a gaze direction of the driver. Based at least in part on determination that the gaze direction of the driver is directed is toward the mirror assembly, the video display screen is electrically operated to display video images at a first brightness, and responsive to determination that the gaze direction of the driver is not directed toward the mirror assembly, the video display screen is electrically operated to display video images at a second brightness that is less than the first brightness.

### CROSS REFERENCE TO RELATED APPLICATIONS

The present application claims the filing benefits of U.S. provisional application Ser. No. 63/656,731, filed Jun. 6, 2024, U.S. provisional application Ser. No. 63/588,347, filed Oct. 6, 2023, and U.S. provisional application Ser. No. 63/579,987, filed Sep. 1, 2023, which are hereby incorporated herein by reference in their entireties.

### FIELD OF THE INVENTION

The present invention relates generally to a vehicular driver or occupant or cabin monitoring system for a vehicle and, more particularly, to a vehicular driver or occupant or cabin monitoring system that utilizes one or more cameras at an interior mirror of a vehicle.

### BACKGROUND OF THE INVENTION

It is known to provide a mirror assembly that is adjustably mounted to an interior portion of a vehicle, such as via a single or double ball pivot or joint mounting configuration where the mirror casing and reflective element are adjusted relative to the interior portion of a vehicle by pivotal movement about the single or double ball pivot configuration. The mirror casing and reflective element are pivotable about either or both of the ball pivot joints by a user that is adjusting his or her rearward view.

### SUMMARY OF THE INVENTION

A vehicular driver monitoring system includes an interior rearview mirror assembly that accommodates a driver monitoring camera. The interior rearview mirror assembly includes a mirror head adjustably attached at a mounting structure. The mounting structure is configured to attach at an interior portion of a cabin of a vehicle equipped with the vehicular driver monitoring system. The mirror head accommodates a mirror reflective element and a video display screen. The video display screen is electrically operable to display video images for viewing by the driver of the vehicle. The driver monitoring camera moves together and in tandem with the mirror head when, with the mounting structure attached at the interior portion of the cabin of the vehicle, the mirror head is adjusted relative to the mounting structure to set a rearward view of the driver of the vehicle. The driver monitoring camera, with the mounting structure attached at the interior portion of the vehicle, and with the mirror head adjusted relative to the mounting structure to set the rearward view of the driver of the vehicle, views at least a driver's head region of the cabin of the vehicle. An electronic control unit (ECU) includes electronic circuitry and associated software. The electronic circuitry of the ECU includes an image processor for processing image data captured by the driver monitoring camera. The vehicular driver monitoring system, based on processing at the ECU of image data captured by the driver monitoring camera, determines a gaze direction of the driver. The vehicular driver monitoring system, based on determination that the gaze direction of the driver directed is at or near the vehicular interior rearview mirror assembly, electrically operates the video display screen to display video images at a first brightness. Based on determination that the gaze direction of the driver is not directed at or near the vehicular interior rearview mirror assembly, the vehicular driver monitoring system electrically operates the video display screen to display video images at a second brightness that is less than the first brightness.

Optionally, the system adjusts brightness of other display screens within the vehicle (e.g., an infotainment display screen, a gauge cluster display screen, and the like) to operate at an increased brightness when the driver is viewing the display screen or screens and to operate at a reduced brightness when the driver is not viewing the display screen or screens.

Optionally, a vehicular driver monitoring system includes an interior rearview mirror assembly that accommodates a driver monitoring camera. The interior rearview mirror assembly includes a mirror head adjustably attached at a mounting structure. The mounting structure is configured to attach at an interior portion of a cabin of a vehicle equipped with the vehicular driver monitoring system. The mirror head accommodates a variable reflectance mirror reflective element. The driver monitoring camera moves together and in tandem with the mirror head when, with the mounting structure attached at the interior portion of the cabin of the vehicle, the mirror head is adjusted relative to the mounting structure to set a rearward view of the driver of the vehicle. The driver monitoring camera views through the variable reflectance mirror reflective element. The driver monitoring camera, with the mounting structure attached at the interior portion of the vehicle, and with the mirror head adjusted relative to the mounting structure to set the rearward view of the driver of the vehicle, views at least a driver's head region of the cabin of the vehicle. An electronic control unit (ECU) includes electronic circuitry and associated software. The electronic circuitry of the ECU includes an image processor for processing image data captured by the driver monitoring camera. The vehicular driver monitoring system, based on processing at the ECU of image data captured by the driver monitoring camera, determines a gaze direction of the driver. The vehicular driver monitoring system, with a gear selector or propulsion system of the vehicle in a park position, and based on determination that the gaze direction of the driver is at or near the vehicular interior rearview mirror assembly, electrically operates a light source at the cabin of the vehicle to emit light and illuminate at least a portion of the cabin of the vehicle. When the gear selector of the vehicle is in a drive position, the driver monitoring system may adjust operation of a display screen based on determination that the gaze direction of the driver is at or near the display screen.

These and other objects, advantages, purposes and features of the present invention will become apparent upon review of the following specification in conjunction with the drawings.

### BRIEF DESCRIPTION OF THE DRAWINGS

FIGS. 1 and 2 are perspective views of a vehicular interior rearview mirror assembly;

FIG. 3 is a diagram showing the total thermal load of the interior rearview mirror assembly including electronic components for a driver monitoring system and video display screen;

FIG. 4 shows ambient light directed toward the driver of the vehicle by the video display screen at the interior rearview mirror assembly, an infotainment display screen, and a gauge cluster display screen;

FIG. 5 shows the interior cabin of the vehicle with borders indicating regions of interest for the gaze direction of the driver determined by the driver monitoring system;

FIG. 6 is a chart showing brightness of the video display screen at the interior rearview mirror assembly when operated along a full power curve and a reduced power curve;

FIG. 7 is a chart showing the operating cycle of the video display screen between the full power curve and the reduced power curve;

FIG. 8 shows the interior cabin of the vehicle with the video display screen at the interior rearview mirror assembly, the infotainment display screen, and the gauge cluster display screen all operating at a reduced brightness level;

FIG. 9 shows the interior cabin of the vehicle with the video display screen at the interior rearview mirror assembly operating at an increased brightness level and the infotainment display screen and the gauge cluster display screen operating at a reduced brightness level;

FIG. 10 shows the interior cabin of the vehicle with the infotainment display screen operating at an increased brightness level and the video display screen at the interior rearview mirror assembly and the gauge cluster display screen operating at a reduced brightness level;

FIG. 11 shows the interior cabin of the vehicle with the gauge cluster display screen operating at an increased brightness level and the video display screen at the interior rearview mirror assembly and the infotainment display screen operating at a reduced brightness level;

FIG. 12 is a perspective view of another vehicular interior rearview mirror assembly;

FIGS. 13 and 14 are exploded views of the interior rearview mirror assembly;

FIG. 15A shows a display screen at a center console of a vehicle operating to display images for viewing by a driver of the vehicle; and

FIG. 15B shows the display screen in sleep mode and not operating to display images.

### DESCRIPTION OF THE PREFERRED EMBODIMENTS

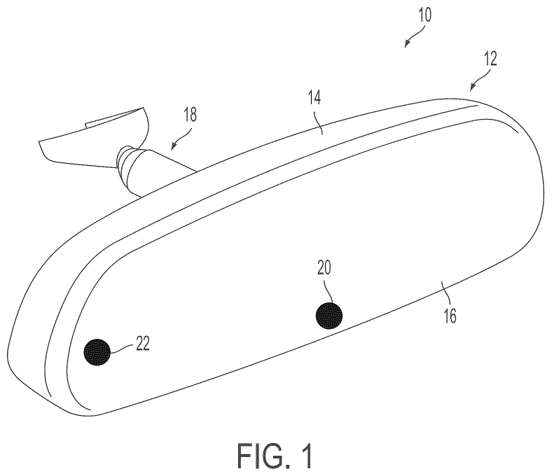

Referring now to the drawings and the illustrative embodiments depicted therein, an interior rearview mirror assembly 10 for a vehicle includes a mirror head 12 that includes a casing 14 and a reflective element 16 positioned at a front portion of the casing 14 (FIG. 1). In the illustrated embodiment, the mirror assembly 10 is configured to be adjustably mounted to an interior portion of a vehicle (such as to an interior or in-cabin surface of a vehicle windshield or a headliner of a vehicle or the like) via a mounting structure or mounting configuration or assembly 18. The mirror reflective element may comprise a variable reflectance mirror reflective element, such as an electrochromic mirror reflective element, that varies its reflectance responsive to electrical current applied to conductive coatings or layers of the reflective element.

The mirror assembly may comprise an auto-dimming mirror reflective element (e.g., an electrochromic mirror reflective element) or a prismatic mirror reflective element. Both types of mirrors may be provided with a video display screen that is disposed behind and is viewable through the mirror reflective element. Such video mirrors include a backlit LCD display screen, and a particular form of video mirror is a full display mirror (such as a ClearView™ Interior Rearview Mirror Assembly available from Magna Mirrors of America, Inc. of Holland, MI USA, or an FDM™ Interior Rearview Mirror Assembly available from Gentex Corporation of Zeeland, MI USA), where the video display screen fills or substantially fills the reflective region, such as by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2019-0258131; US-2019-0146297; US-2019-0118717 and/or US-2017-0355312, which are all hereby incorporated herein by reference in their entireties. When electrically operated to display images through the mirror reflective element 16, the video display screen generates heat within the mirror head 12.

Thus, the mirror assembly may comprise a dual-mode mirror that is operable between a reflection mode and a video display mode. When the dual-mode mirror is operating in the reflection mode, the video display screen does not operate to display video images so that, when the driver is viewing the mirror reflective element, the driver views reflections off a mirror reflector of the mirror reflective element to view rearward of the vehicle via the mirror assembly. When the dual-mode mirror is operating in the video display mode, the video display screen is operated to display video images that are viewable by the driver through the mirror reflective element. For example, the video images may be generated based on imaged data captured by a rearward viewing camera of the vehicle and representative of the rearward view of the driver.

Further, the mirror assembly 10 includes or is associated with a driver monitoring system (DMS) and/or an occupant monitoring system (OMS), with the mirror assembly including a driver/occupant monitoring camera 20 disposed at a back plate (and viewing through an aperture of the back plate) behind the reflective element 16 and viewing through the reflective element 16 toward at least a head region of the driver of the vehicle. The DMS may include an infrared light (IR light) or near infrared light (near IR light) emitter 22 disposed at the back plate and emitting IR light or near IR light that passes through another aperture of the back plate and through the reflective element 16. Further, the monitoring system includes an electronic control unit (ECU) having electronic circuitry and associated software, including an image processor for processing image data captured by the DMS/OMS camera. Image data captured by the camera may be processed for a head and face direction and position tracking system and/or eye tracking system and/or gesture recognition system. The DMS camera and monitoring system and/or head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2024-0190456; US-2024-0168355; US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. provisional application Ser. No. 63/641,574, filed May 2, 2024 (Attorney Docket DON01 P5156), and/or International Publication No. WO 2023/220222, which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from a forward or outward viewing camera, as well as from a rearward viewing camera and sideward viewing cameras of the CMS, to provide the driver with unique collision mitigation capabilities based on full vehicle environment and driver awareness state. The image processing and detections and determinations are performed locally within the interior rearview mirror assembly and/or the overhead console region, depending on available space and electrical connections for the particular vehicle application. The CMS cameras and system may utilize aspects of the systems described in U.S. Pat. No. 11,242,008 and/or U.S. Publication Nos. US-2024-0064274; US-2021-0245662; US-2021-0162926; US-2021-0155167; US-2018-0134217 and/or US-2014-0285666, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at the interior rearview mirror assembly or at a central console or the like) for viewing by a driver of the vehicle. The system may utilize aspects of the systems described in U.S. Pat. Nos. 11,242,008; 10,442,360 and/or 10,046,706, and/or U.S. Publication Nos. US-2024-0064274; US-2021-0245662; US-2021-0162926; US-2021-0155167 and/or US-2019-0118717, which are all hereby incorporated herein by reference in their entireties.

Electronic components associated with the DMS and/or the CMS generate heat at the interior of the mirror head 12. For example, the near IR light emitter 22, when electrically operated to emit light through the mirror reflective element 16, generates heat. Further, the ECU disposed within the mirror head includes one or more data processors or image processors for processing image data and/or sensor data for the DMS, OMS, and/or CMS functions. When the one or more processors are operated to process the sensor data, heat is generated within the mirror head 12.

With the DMS camera 20 disposed in the mirror head 12, the camera 20 moves together and in tandem with the mirror head 12 (including the mirror casing 14 and mirror reflective element 16 that pivot at a pivot joint that pivotally connects the mirror head to the mounting structure 18 of the interior rearview mirror assembly that in turn mounts at a windshield or at a headliner of the equipped vehicle), such that, when the driver aligns the mirror head 12 to view rearward, the camera 20 is positioned so as to view at least the driver of the vehicle. The location of the DMS camera 20 and IR LED(s) 22 at the mirror head 12 provides an unobstructed view to the driver.

As discussed further below, the DMS of the vehicle processes image data captured by the DMS camera 20 to determine a gaze direction for the driver and/or occupants of the vehicle, such as to determine whether the driver is looking at the road or at a location within the cabin of the vehicle. For example, the DMS may determine that the driver is looking directly at the interior rearview mirror assembly. Based on determination of where the driver is looking, the system controls operation of one or more electronic components within the cabin of the vehicle, such as lighting, an information display, the video display screen at the mirror assembly, and the like.

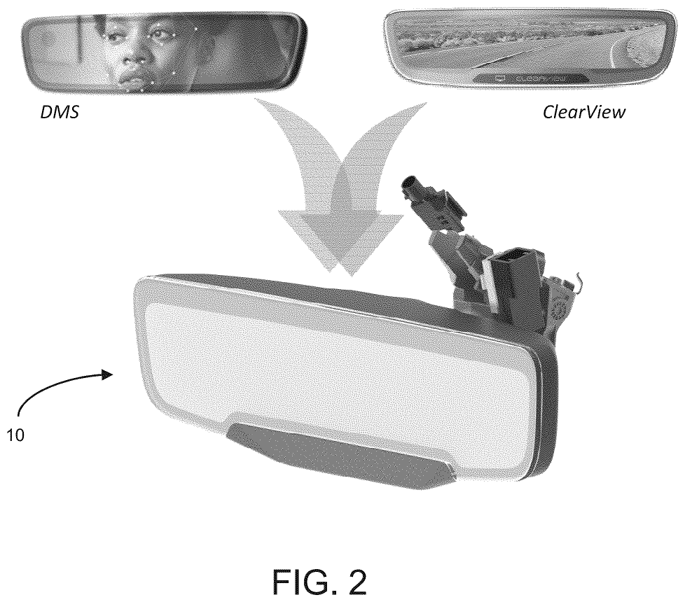

Referring to FIGS. 2 and 3, the mirror head 12 accommodates electronic components associated with the DMS of the vehicle (e.g., the DMS camera 20 and light emitter 22), the video display screen 24, the dimmable electrochromic mirror reflective element 16, and electronic circuitry of the ECU that provides processing for the DMS, video display screen, and/or control of the electrochromic mirror reflective element 16. Operation of these systems may present a significant thermal load within the mirror head 12. For example, the electronic circuitry associated with the DMS may provide a thermal load of 2.6 Watts or more, the DMS light emitter 22 may provide a thermal load of 2 Watts or more, the DMS camera 20 may provide a thermal load of 0.3 Watts or more, the electronic circuitry associated with the video display screen may provide a thermal load of 6.9 Watts or more, the video display screen may provide a thermal load of 8 Watts or more when operated at full brightness, and the electronic circuitry associated with the electrochromic mirror reflective element 16 may provide a thermal load of 0.3 Watts or more. Thus, the mirror assembly 10 may have a thermal load of 20.6 Watts or more.

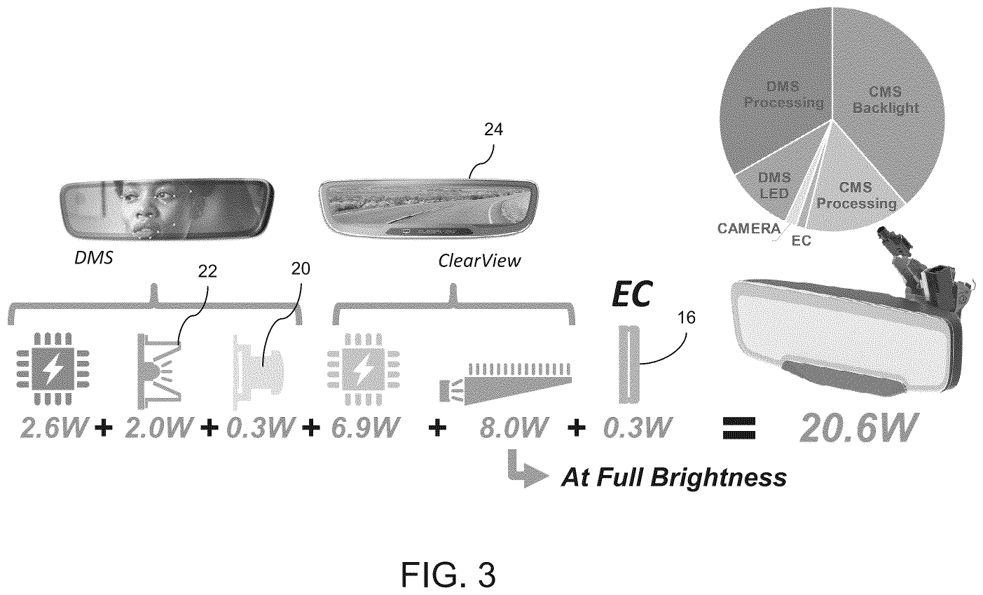

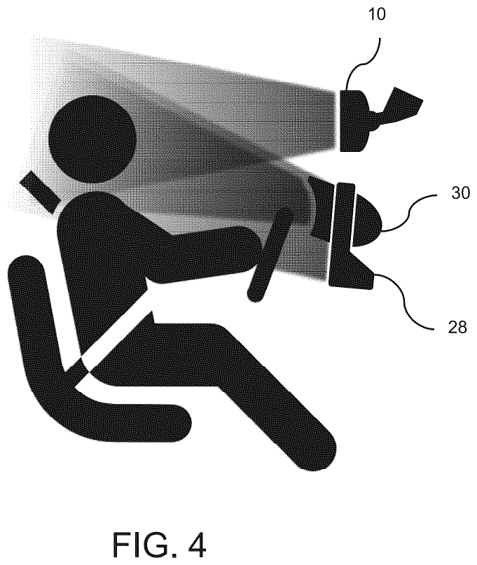

Further, and such as shown in FIGS. 4 and 5, one or more video display screens, in addition to the video display screen 24 at the mirror assembly 10, may be disposed within the interior cabin 26 of the vehicle. For example, an infotainment display 28 may be disposed at a center console or center stack region of the cabin 26 and the vehicle may include a digital gauge or instrument cluster display 30. Optionally, one or more backlit buttons or icons and/or ambient lights or accent lighting may be disposed within the cabin 26. Collectively, the video display screen 24 at the mirror assembly 10, the infotainment display 28, the digital gauge cluster display 30, backlit buttons or icons, and/or accent lighting may distract or irritate the driver when all are operated at full brightness. In other words, the one or more electrically operable lights within the vehicle cabin 26 may add unnecessary glare toward the driver.

To reduce the thermal load at the mirror assembly 10 and the ambient light directed toward the driver from the video display screen 24 at the mirror assembly 10, the system may adjust brightness of the video display screen 24 based on the determined gaze direction of the driver toward the interior rearview mirror assembly 10. Further, to reduce the ambient light directed toward the driver, the system may adjust brightness of one or more of the infotainment display screen 28, the gauge cluster display screen 30, and backlit buttons based on the determined gaze direction of the driver within the cabin 26 of the vehicle.

For example, the DMS (e.g., an image processor of the ECU of the DMS) processes image data captured by the camera 20 at the mirror assembly 10 to determine a region of interest (ROI) corresponding to the gaze direction of the driver, where the ROI includes a region within the cabin 26 of the vehicle at which the driver's gaze is directed. The DMS may be operable to determine that the driver is viewing ROIs that include an upper portion of the windshield, a left or driver side of the windshield, a right or passenger side of the windshield, the interior rearview mirror assembly 10, the driver side exterior rearview mirror, the passenger side exterior rearview mirror, the gauge cluster display screen 30, the infotainment display screen 28, the glovebox, the dashboard, the center console area (at which backlit buttons may be disposed), a driver lap and/or foot well region, a passenger lap and/or foot well region, a far left or driver side door region, a far right or passenger side door region, and the like (FIG. 5).

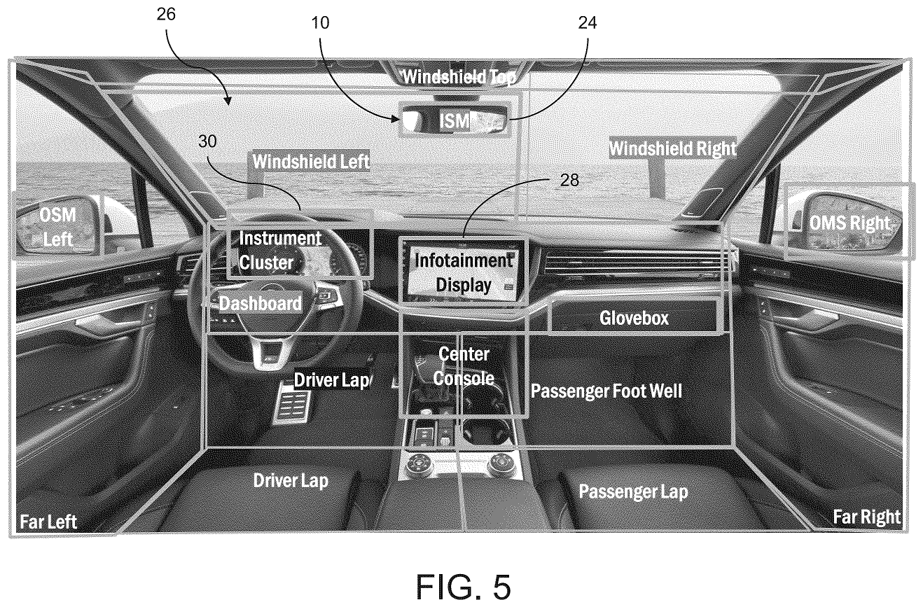

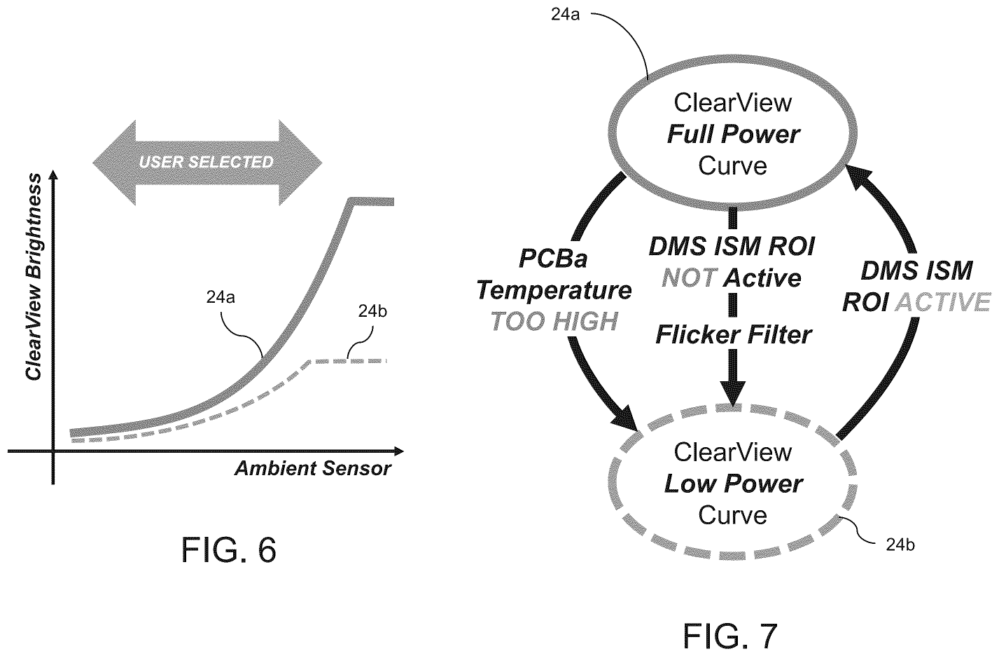

Referring to FIGS. 6 and 7, when the video display screen 24 at the mirror assembly 10 is operated to display video images, operation of the video display screen 24 may be adjustable along and between a full power curve 24a and a reduced power curve 24b. That is, when the video display screen 24 is operated on the full power curve 24a, the brightness of the video display screen 24 is adjusted between brightness levels included on the full power curve 24a. When the video display screen 24 is operated on the reduced power curve 24b, the brightness of the video display screen 24 is adjusted between brightness levels included on the reduced power curve 24b. Operation of the video display screen 24 is adjustable between the full power curve 24a and the reduced power curve 24b. Further, brightness of the video display screen 24 along the full power curve 24a and the reduced power curve 24b may be adjusted based on a determined ambient light level at the interior rearview mirror. Optionally, brightness of the video display screen 24 along the full power curve 24a and the reduced power curve 24b may be adjusted based on a user input.

When the video display screen 24 is operated along the full power curve 24a, brightness of the video display screen 24 may be adjustable up to the maximum brightness capability (and thus maximum thermal load) of the video display screen 24. When the video display screen 24 is operated along the reduced power curve 24b, brightness of the video display screen 24 may be capped or limited to a threshold level of brightness (and thus the thermal load is reduced), such as to 80 percent or less of the video display screen's brightness capability, 60 percent or less of the video display screen's brightness capability, 50 percent or less of the video display screen's brightness capability, 30 percent of the video display screen's brightness capability, and the like. Brightness values along the full power curve 24a may correspond to brightness values along the reduced power curve 24b, such that each brightness value along the reduced power curve 24b is based on a percentage of the corresponding brightness value along the full power curve 24a (e.g., 80 percent, 60 percent, 50 percent, 30 percent, and the like).

During operation of the video display screen 24, the DMS may process image data captured by the camera 20 to determine whether the gaze direction of the driver is directed toward the interior rearview mirror assembly 10. Based on determination that the driver is viewing the interior rearview mirror assembly 10, the video display screen 24 may be operated along the full power curve 24a. Based on determination that the driver is not viewing the interior rearview mirror assembly 10 or that the driver is viewing a region other than the interior rearview mirror assembly, the video display screen 24 may be operated along the reduced power curve 24b and/or the video display screen 24 may be operated with a flicker filter to reduce brightness of the video display screen 24 and reduce the thermal load at the mirror assembly 10. In other words, the video display screen 24 may be operated at increased brightness when the driver is viewing the video display screen 24 and the video display screen 24 may be operated at reduced brightness when the driver is looking away from the video display screen 24.

Thus, the system may cycle between operating the video display screen 24 along the full power curve 24a or at full brightness and operating the video display screen 24 along the reduced power curve 24b or at reduced brightness. Optionally, the system may only cycle between full brightness and reduced brightness when the thermal load or temperature at the mirror assembly is greater than a threshold thermal load or temperature. For example, the system may begin cycling the video display screen 24 between full brightness and reduced brightness when the ambient temperature at the vehicle is greater than a threshold temperature (e.g., greater than 70 degrees Fahrenheit, greater than 80 degrees Fahrenheit, greater than 90 degrees Fahrenheit, and the like) or when the video display screen has been operating for longer than a threshold period of time (e.g., longer than 10 minutes, longer than 30 minutes, longer than 1 hour, and the like).

Cycling operation of the video display screen 24 between full brightness and reduced brightness may significantly reduce the thermal load at the mirror assembly 10. For example, because the driver does not view the interior rearview mirror assembly 10 at all times, the video display screen 24 may be operated at full brightness for about 10 percent of the time and the video display screen 24 may be operated at reduced brightness (e.g., at 50 percent brightness) for about 90 percent of the time, which results in a reduction in the thermal load at the mirror assembly 10 of about 18 percent or 3.8 Watts. The reduced thermal load may reduce the external temperature of the mirror assembly, thus reducing discomfort or risk of injury when the driver grasps the mirror assembly to adjust the position of the mirror head. Further, the reduced thermal load allows the systems at the mirror head to continue operation at higher ambient temperatures before scaling back operation to reduce thermal load from other electronic components.

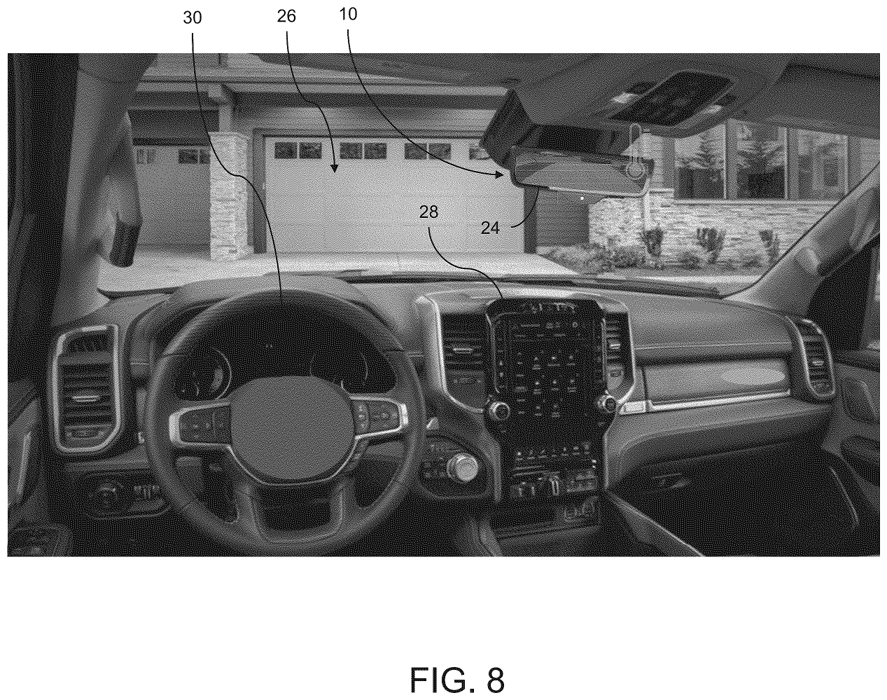

As shown in FIGS. 8-11, the DMS may determine the gaze direction of the driver and control operation of the video display screen 24 at the mirror assembly 10, the infotainment display screen 28, and the gauge cluster display screen 30 to increase brightness of the respective screen when viewed by the driver and reduce brightness of the respective screen when not viewed by the driver. For example, FIG. 8 shows that the driver is not viewing any of the video display screen 24 at the mirror assembly 10, the infotainment display screen 28, and the gauge cluster display screen 30 (e.g., the driver is looking through the windshield at the road in front of the vehicle) and thus each of the video display screen 24 at the mirror assembly 10, the infotainment display screen 28, and the gauge cluster display screen 30 are operated at reduced brightness.

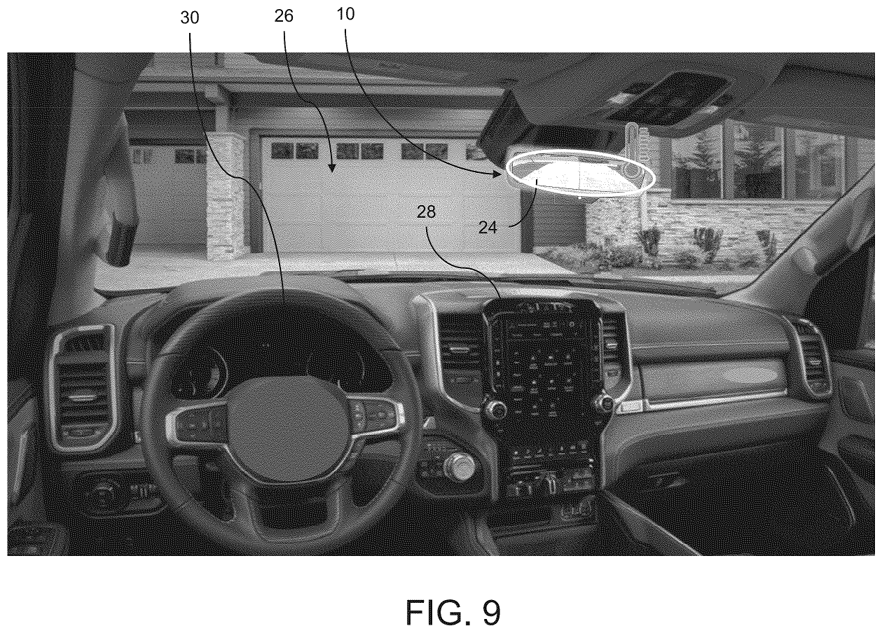

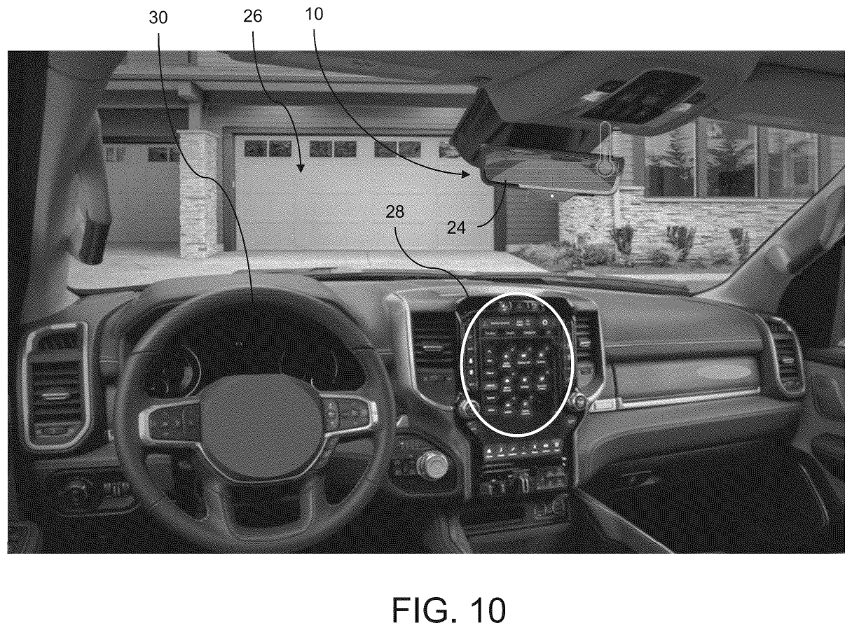

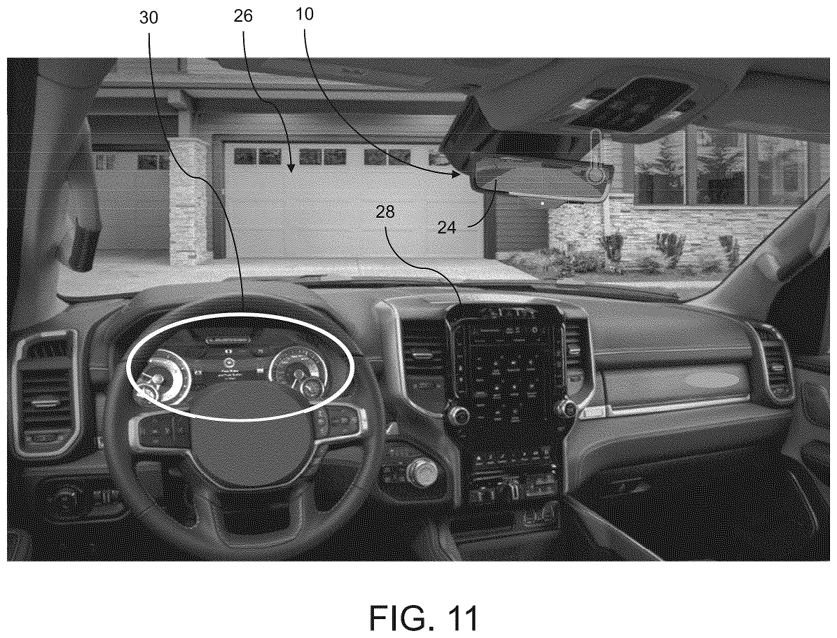

As shown in FIG. 9, based on determination that the driver is viewing the interior rearview mirror assembly 10, the video display screen 24 is operated at full brightness or increased brightness while the infotainment display screen 28, and the gauge cluster display screen 30 are operated at minimum brightness or reduced brightness. As shown in FIG. 10, based on determination that the driver and/or the occupant is viewing the infotainment display screen 28, the infotainment display screen 28 is operated at full brightness or increased brightness while the video display screen 24 at the mirror assembly 10 and the gauge cluster display screen 30 are operated at minimum brightness or reduced brightness. As shown in FIG. 11, based on determination that the driver is viewing the gauge cluster display screen 30, the gauge cluster display screen 30 is operated at full brightness or increased brightness while the video display screen 24 at the mirror assembly 10 and the infotainment display screen 28 are operated at minimum brightness or reduced brightness. Optionally, the system may operate multiple display screens at full brightness or increased brightness, such as operating the gauge cluster display screen 30 and the infotainment display screen 28 at full brightness or increased brightness and operating the video display screen 24 at the mirror assembly 10 at minimum brightness or reduced brightness based on determination that the driver is viewing the gauge cluster display screen 30 and the occupant is viewing the infotainment display screen 28.

Thus, the system determines the driver's gaze direction to adjust the brightness of the rearview mirror display screen 24. If the driver gazes at or near the interior rearview mirror assembly 10, the DMS system may increase the brightness of the rearview mirror display screen 24. When the driver is not looking at the rearview mirror assembly 10, the brightness of the display screen 24 may be reduced or turned off. This reduces the total thermal impact of the display on the system. For example, if the display is only running at high brightness for short duty cycles, then the overall system may perform better at higher temperatures. This thermal rollback of brightness based on user gaze direction may be on all the time or only when thermally needed.

Further, the DMS may determine the gaze direction of the driver and the ROI within the cabin viewed by the driver and brighten or reduce brightness of display items based on the ROI being viewed. Because the DMS may determine the gaze direction of the driver in a relatively short time period (such as 66 milliseconds or less), the system may quickly adjust brightness of a particular display screen or illumination source based on determination that the driver is viewing the particular display or illumination source (e.g., a backlit icon or button).

The light emitters 22 are accommodated by the mirror head, such as behind the mirror reflective element or at a chin region of the mirror head below (or optionally above or to the side of) the mirror reflective element. Optionally, and such as shown in FIG. 1, the light emitters may be disposed at the left side of the mirror head or driver's side of the mirror head (i.e., closest to the driver for a left hand drive vehicle), so that less power is needed to sufficiently illuminate the driver's head region when the light emitters 22 are electrically operated to emit light. Because it may be possible for the driver to adjust the driver-side sun visor to be at a location where the sun visor at least partially blocks the light emitted by the light emitters from illuminating the driver's head region, the system may, via processing of image data captured by the driver monitoring camera, determine when the sun visor is at an orientation or location that blocks the emitted light (and determine when the sun visor is at an orientation or location that blocks the view of the driver monitoring camera).

Responsive to determining that the sun visor is at least partially blocking the emitted light from illuminating the driver's head region and/or blocking the view of the DMS camera viewing the driver's head, the system may generate an alert to the driver to adjust the sun visor so that it no longer blocks the emitted light or camera's view. For example, the alert may include an audio message played over a sound system of the vehicle and/or a visual text or iconistic message displayed at a display screen (e.g., at the interior rearview mirror assembly or infotainment system or gauge cluster) within the cabin of the vehicle. Optionally, the system may be operable to control the position of the sun visor to automatically adjust the sun visor responsive to determining that the sun visor is at least partially blocking the emitted light from reaching the driver's head region and/or blocking the view of the DMS camera viewing the driver's head. The system may determine the blocking condition of the sun visor by detecting reflection of emitted light off the sun visor or by detecting lack of light at the driver's head region when the light emitters are activated or by determining the orientation of the sun visor (via processing of image data captured by the DMS camera) and determining whether or not that orientation results in a blocking condition based on the mirror head orientation and location of the driver's head (as may also be determined via processing of image data captured by the DMS camera).

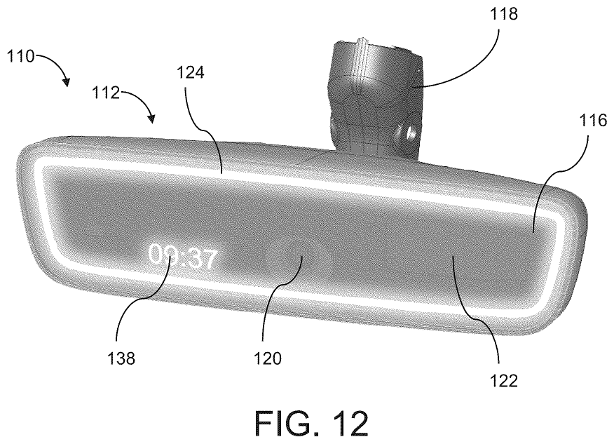

Optionally, one or more electronic systems or devices or displays within the interior cabin of the vehicle may be operated based on the gaze direction of the driver and/or occupant of the vehicle determined by the DMS/OMS. That is, based on the determined gaze direction of the driver and/or occupant of the vehicle corresponding to an electronic component of the vehicle, operation of the electronic component may be actuated and/or adjusted. For example, and in reference to FIGS. 12-16B, the mirror assembly 110 is configured to be adjustably mounted to an interior portion of a vehicle (such as to an interior or in-cabin surface of a vehicle windshield or a headliner of a vehicle or the like) via a mounting structure or mounting configuration or assembly 118. The mirror reflective element may comprise a variable reflectance mirror reflective element, such as an electrochromic mirror reflective element, that varies its reflectance responsive to electrical current applied to conductive coatings or layers of the reflective element.

The mirror assembly 110 includes or is associated with a driver monitoring system (DMS) and/or an occupant monitoring system (OMS), with the mirror assembly including a driver/occupant monitoring camera 120 disposed at a back plate (and viewing through an aperture of the back plate) behind the reflective element 116 and viewing through the reflective element 116 toward at least a head region of the driver of the vehicle. The DMS may include an infrared light (IR light) or near infrared light (near IR light) emitter 122 disposed at the back plate and emitting IR light or near IR light that passes through another aperture of the back plate and through the reflective element 116. Further, the monitoring system includes an electronic control unit (ECU) having electronic circuitry and associated software, including an image processor for processing image data captured by the DMS/OMS camera. Image data captured by the camera may be processed for a head and face direction and position tracking system and/or eye tracking system and/or gesture recognition system.

With the DMS camera 120 disposed in the mirror head 112, the camera 120 moves together and in tandem with the mirror head 112 (including the mirror casing 114 and mirror reflective element 116 that pivot at a pivot joint that pivotally connects the mirror head to the mounting structure 118 of the interior rearview mirror assembly that in turn mounts at a windshield or at a headliner of the equipped vehicle), such that, when the driver aligns the mirror head 112 to view rearward, the camera 120 is positioned so as to view at least the driver of the vehicle. The location of the DMS camera 120 and IR LED(s) 122 at the mirror head 112 provide an unobstructed view to the driver. The driver monitoring camera 120 may also provide captured image data for a cabin monitoring system or occupancy monitoring system (OMS) or another separate OMS camera may be disposed at the mirror assembly for the OMS function.

As discussed further below, the DMS of the vehicle processes image data captured by the DMS camera 120 to determine a gaze direction for the driver and/or occupants of the vehicle, such as to determine whether the driver is looking at the road or at a location within the cabin of the vehicle. For example, the DMS may determine that the driver is looking directly at the interior rearview mirror assembly. Based on determination of where the driver is looking, the system controls operation of one or more electronic components within the cabin of the vehicle, such as lighting, an information display, and the like.

Often, drivers and/or occupants of a vehicle elect to use the interior rearview mirror as a vanity mirror when the vehicle is parked. In other words, the driver or occupant may move their head close to the interior rearview mirror to view their appearance at the mirror reflective element. For example, use of the interior rearview mirror is hands-free and requires fewer steps to use as compared to a vanity mirror at the underside of a sun visor of the vehicle. To use the interior rearview mirror as a vanity mirror when there is little to no ambient light within the vehicle, some level of manual action by the driver or occupant is typically required to illuminate the cabin of the vehicle, such as switching on the overhead console map lights to use the interior rearview mirror or unfolding the sun visor and/or vanity glass cover.

Referring to FIGS. 12-14, the interior rearview mirror assembly 110 includes the DMS camera 120 that views through the mirror reflective element 116 and the DMS operates a light source at the interior cabin of the vehicle based on determination, via processing of image data captured by the DMS camera 120, that the driver or occupant is looking at or toward the mirror 110. To avoid activating the light source when the vehicle is travelling along the road, the system may only operate the light source when a gear selector or propulsion system of the vehicle is in a park position or selection and the system determines that the driver or occupant is looking at or toward the mirror 110. Optionally, the system may also operate the light source when the vehicle is moving forward below a threshold speed, such as 5 mph or 7 mph.

The system may control operation of any light source inside the cabin of the vehicle that is suitable for providing illumination for the driver or occupant looking at their own reflection in the reflective element 116 of the mirror 110. For example, the system may operate a map light or reading light at an overhead console module of the vehicle to emit light, or the system may operate a dome light along a headliner of the vehicle to emit light. Optionally, the system may operate one or more specific light sources at the interior of the vehicle based on whether the driver or another occupant is viewing the interior rearview mirror assembly 110. For example, if the system determines that the driver is viewing the mirror assembly 110, the system may operate a map light at the overhead console module that corresponds to and illuminates the driver side of the vehicle and, if the system determines that an occupant at the passenger side is viewing the mirror assembly 110, the system may operate a map light at the overhead console module that corresponds to and illuminates the passenger side of the vehicle.

Further, the mirror assembly 110 may include one or more light sources 124 that, when electrically operated, emit visible light that illuminates the cabin of the vehicle and the system may operate the integrated light source 124 responsive to determination that the driver or occupant is viewing the mirror assembly 110. In the illustrated example, the light source 124 at the mirror assembly 110 includes a vanity ring light, such as a strip or panel of light emitting diodes (LEDs) that at least partially circumscribe the mirror reflective element 116. The light source 124 may be disposed behind the mirror reflective element 116 and emit light that passes through the mirror reflective element 116 toward the cabin of the vehicle. When the vehicle is in park and the system determines that the driver or occupant is looking at the mirror assembly 110, the system electrically operates the light source 124 to emit light and illuminate the mirror reflective element 116 and/or the cabin of the vehicle.

Optionally, the light source may be disposed at the mirror assembly and at an exterior or perimeter region of the mirror head. That is, the light source may not be disposed behind the mirror reflective element so that, when the light source is electrically operated, the light does not pass through the mirror reflective element to illuminate the cabin. For example, the light source may be disposed along a peripheral edge region of the mirror reflective element 116, such as at least partially circumscribing the mirror reflective element 116 or respective light sources may be disposed along opposing sides of the mirror reflective element. The light source may be disposed between at least a portion of the peripheral edge of the mirror reflective element and the mirror casing.

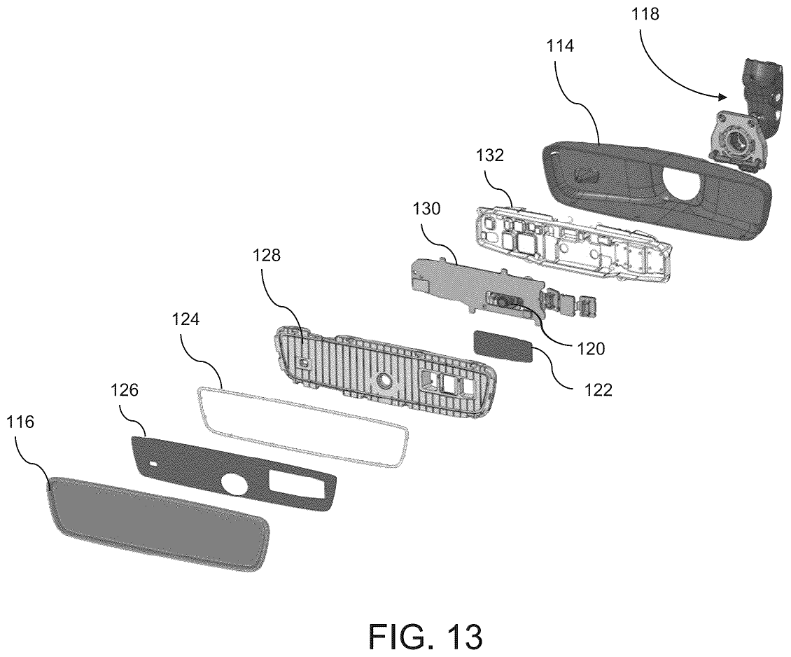

As shown in FIGS. 13 and 14, the mirror assembly 110 includes a foam tape or adhesive element 126 that attaches at a rear surface of the electrochromic mirror reflective element 116. The foam tape 126 attaches the mirror reflective element 116 to a mirror back plate or fixture plate 128. An electronics subassembly 130, such as a printed circuit board (PCB), accommodates the camera 120 and the IR light emitter 122 and is disposed at a rear surface of the mirror back plate 128 so that the camera 120 and IR light emitter are respectively aligned with apertures in the back plate 128 and the foam tape 126. The light source 124 is disposed at a front surface of the back plate 128 facing the mirror reflective element 116 and circumscribes the foam tape 126. The light source 124 may be electrically connected to the PCB 130 for electrically powering the light source 124. Further, a heat sink 132 may be disposed between the PCB 130 and the mirror casing 114 for dissipating heat generated by the electronic components and/or light source interior of the mirror assembly to the exterior of the mirror assembly.

Thus, when the vehicle is in park and the DMS determines that the driver or occupant is looking at or toward the mirror assembly 110, the system operates a light source within the vehicle (such as the light source 124 at the mirror assembly) to illuminate the mirror reflective element 116 and/or at least a portion of the cabin of the vehicle. Optionally, the system operates the light source based on determination that the level of ambient light at the vehicle is below a threshold level, such as based on processing of sensor data captured by an ambient light sensor (or the DMS camera) at the mirror assembly. In other words, the system may only operate the light source when the vehicle is in park, the driver or occupant is looking at the mirror assembly, and the system determines that illumination levels within the cabin of the vehicle are low.

Optionally, the system operates the light source based on determination that the proximity of the driver or occupant's head to the rearview mirror assembly is below a threshold distance. Thus, the system may operate the light source based on the driver or occupant moving their head/face closer to the mirror. For example, an IR proximity sensor may be disposed behind the mirror reflective element, or the DMS may act as an IR proximity sensor based on processing of image data representative of IR light captured by the DMS camera.

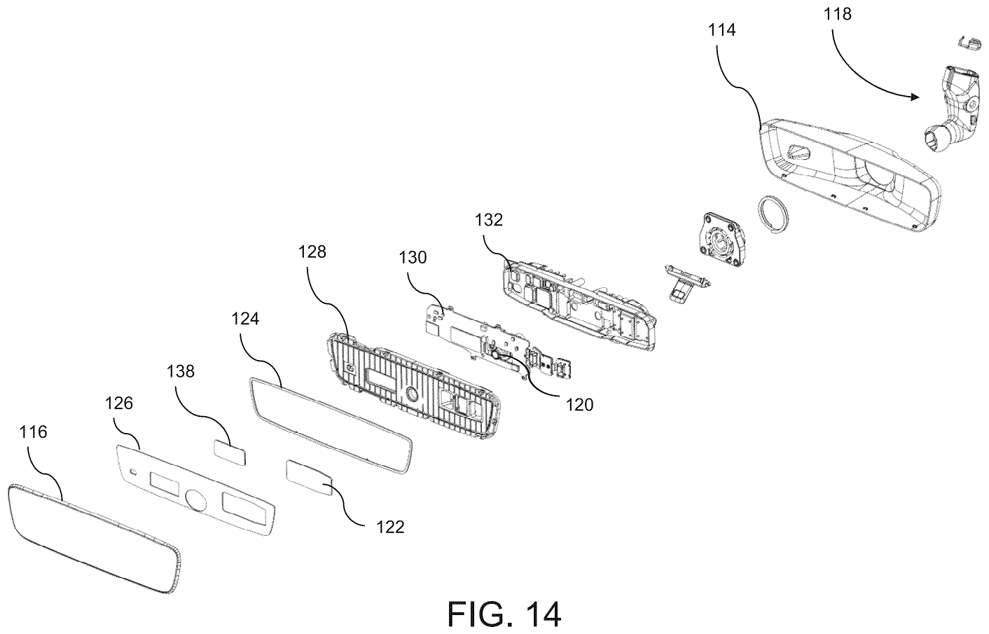

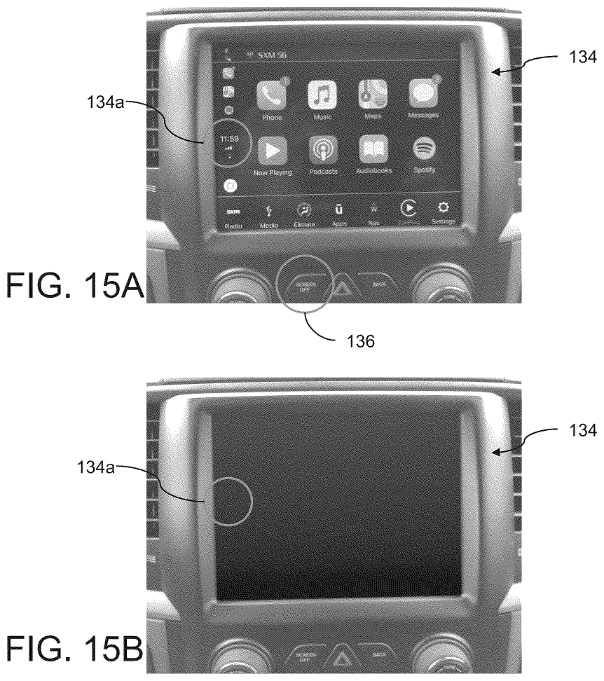

Optionally, the system may actuate or adjust operation of one or more electronic components within the vehicle cabin, such as a display screen, based on the determined gaze direction of the driver. For example, and referring to FIGS. 15A and 15B, the vehicle may include a display screen 134 (e.g., a touchscreen display) of an infotainment system at the center console or center stack of the vehicle. The vehicle may include a user input 136 for placing the display screen 134 in a “screen off” or sleep mode where the display screen is not operated to display images to the driver of the vehicle, such as to help reduce driver distraction and/or eye strain for the driver. However, when the display screen 134 is in the sleep mode, important at-a-glance information, such as a clock, ambient exterior temperature, and climate control status, is lost. For example, the display screen 134 may display this information at a portion 134a of the display screen 134 and the vehicle may not include a standalone persistent clock or information module such as due to interior styling constraints and/or because the display screen 134 consumes significant packaging space in the center stack or center console area.

Based on determination that the driver is looking at or near the display screen 134, the DMS may adjust the display at the display screen 134. For example, if the display screen 134 is in the sleep mode, the system may activate the display screen 134 or deactivate sleep mode to display conventional images at the display screen 134 when the driver is looking at or near the display screen 134. Optionally, if the display screen 134 is in the sleep mode, the system may operate the display screen 134 to display simplified images when the driver is looking at the display screen 134, such as images that include a set of information (e.g., at least one of a clock, an exterior ambient temperature, a climate control status, a directional heading of the vehicle, information related to a radio station or song selection or audio being played by the infotainment system, and the like). For example, the system may activate the display screen to display the images at the portion 134a of the display screen while not displaying images at other portions of the display screen. The displayed set of information may be configurable by the driver of the vehicle.

Optionally, the system may deactivate the display screen 134 or place the display screen in sleep mode based on determination that the driver has been viewing the display screen 134 longer than a threshold period of time (e.g., 30 seconds or more, 1 minute or more, and the like) while the vehicle is travelling along the road. In other words, the system may determine that the driver is distracted from looking at the display screen 134 and the system adjusts images displayed at the display screen 134 to reduce the distraction provided to the driver.

Thus, when the vehicle is travelling along the road (such as determined based on the gear selector or propulsion system of the vehicle being selected to be in a driving gear or forward/reverse propulsion setting), the DMS may determine that the driver is looking at or near the display screen 134 and adjust images displayed at the display screen 134. For example, if the display screen 134 is in sleep mode, the system may operate the display screen 134 to display at least a limited set of images at the display screen 134 based on determination that the driver is viewing the display screen 134.

Further, and such as shown in FIGS. 12-14, a display screen 138 may be disposed at the interior rearview mirror assembly 110 and operable to emit light through the mirror reflective element 116 that is viewable by the driver. For example, the display screen or element 138 is disposed at the PCB 130 and aligned with an aperture in the back plate 128 and the foam tape 126. The display screen 138, when operated, may display images (e.g., images captured by a rearview camera of the vehicle) or messages or icons (e.g., a clock, an exterior ambient temperature, a directional heading of the vehicle, information related to a telecommunications system of the vehicle, and the like) for viewing by the driver of the vehicle.

The system may operate the display screen 138 as the vehicle travels along the road based on determination that the driver is looking at or near the rearview mirror assembly 110. For example, the telecommunications system of the vehicle may alert the driver of the vehicle to an incoming telephone call via audio tones played via a speaker of the vehicle and, based on the driver looking toward the rearview mirror assembly, the system may display a message at the display screen related to the incoming telephone call (e.g., caller ID).

Thus, the interior rearview mirror assembly includes a DMS camera 120 (and optionally a near IR light emitter 122) that is associated with a DMS of the vehicle. The DMS processes image data captured by the camera 120 to determine a gaze direction of the driver or occupant of the vehicle. When the vehicle is parked and the system determines that the driver or occupant is looking at or near the rearview mirror assembly, the system operates a light source at the cabin of the vehicle to illuminate the rearview mirror assembly and/or at least a portion of the cabin. The light source may include a light source at the overhead console module of the vehicle or headliner of the vehicle or a light source integrated with the mirror assembly. When the vehicle is travelling along the road and the system determines that the driver is looking at or near the rearview mirror assembly, the system may operate a display screen at the rearview mirror assembly to display an image or message to the driver of the vehicle. Based on determination that the driver is looking at or near a display screen at a center console of the vehicle, the system may operate the display screen to adjust images displayed at the display screen, such as to wake the display screen from a sleep mode or display a configurable set of information to the driver.

The interior mirror assembly may comprise a dual-mode interior rearview video mirror that can switch from a traditional reflection mode to a live-video display mode, such as is by utilizing aspects of the mirror assemblies and systems described in U.S. Pat. Nos. 11,242,008; 11,214,199; 10,442,360; 10,421,404; 10,166,924; 10,046,706 and/or 10,029,614, and/or U.S. Publication Nos. US-2021-0162926; US-2021-0155167; US-2020-0377022; US-2019-0258131; US-2019-0146297; US-2019-0118717 and/or US-2017-0355312, which are all hereby incorporated herein by reference in their entireties. The video display screen of the video mirror, when the mirror is in the display mode, may display video images derived from video image data captured by a rearward viewing camera, such as a rearward camera disposed at a center high-mounted stop lamp (CHMSL) location, and/or video image data captured by one or more other cameras at the vehicle, such as side-mounted rearward viewing cameras or the like, such as by utilizing aspects of the display systems described in U.S. Pat. No. 11,242,008, which is hereby incorporated herein by reference in its entirety. The operating mode of the mirror and video display screen may be selected by flipping the mirror head upward or downward (e.g., via a toggle located at the mirror head) or responsive to another user input. When the mirror is operating in the mirror mode, the video display screen is deactivated and rendered covert by the mirror reflective element, and the driver views rearward via reflection of light incident at the mirror reflective element. When the mirror is operating in the display mode, the video display screen is operated to display video images that are viewable through the mirror reflective element by the driver of the vehicle.

The mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184,190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

Although shown as an electrochromic mirror application, it is envisioned that the mirror assembly may comprise a prismatic reflective element. The prismatic mirror assembly may be mounted or attached at an interior portion of a vehicle (such as at an interior surface of a vehicle windshield) via the mounting means described above, and the reflective element may be toggled or flipped or adjusted between its daytime reflectivity position and its nighttime reflectivity position via any suitable toggle means, such as by utilizing aspects of the mirror assemblies described in U.S. Pat. Nos. 6,318,870 and/or 7,249,860, and/or U.S. Publication No. US-2010-0085653, which are hereby incorporated herein by reference in their entireties. Optionally, for example, the interior rearview mirror assembly may comprise a prismatic mirror assembly, such as the types described in U.S. Pat. Nos. 7,289,037; 7,249,860; 6,318,870; 6,598,980; 5,327,288; 4,948,242; 4,826,289; 4,436,371 and/or 4,435,042, which are hereby incorporated herein by reference in their entireties. Optionally, the prismatic reflective element may comprise a conventional prismatic reflective element or prism or may comprise a prismatic reflective element of the types described in U.S. Pat. Nos. 7,420,756; 7,289,037; 7,274,501; 7,249,860; 7,338,177 and/or 7,255,451, which are all hereby incorporated herein by reference in their entireties.

Optionally, the mirror assembly may include one or more other displays, such as the types disclosed in U.S. Pat. Nos. 5,530,240 and/or 6,329,925, which are hereby incorporated herein by reference in their entireties, and/or display-on-demand transflective type displays, and/or video displays or display screens, such as the types disclosed in U.S. Pat. Nos. 8,890,955; 7,855,755; 7,338,177; 7,274,501; 7,255,451; 7,195,381; 7,184,190; 7,046,448; 5,668,663; 5,724,187; 5,530,240; 6,329,925; 6,690,268; 7,734,392; 7,370,983; 6,902,284; 6,428,172; 6,420,975; 5,416,313; 5,285,060; 5,193,029 and/or 4,793,690, and/or in U.S. Pat. Pub. Nos. US-2006-0050018; US-2009-0015736; US-2009-0015736; and/or US-2010-0097469, which are all hereby incorporated herein by reference in their entireties.

Optionally, the DMS camera may be used to detect ambient light and/or glare light (emanating from headlamps of a trailing vehicle) for use in providing auto-dimming of the EC mirror reflective element. The processing of image data captured by the DMS camera may be adjusted to accommodate the angle of the mirror head so that the ECU or system, via image processing of image data captured by the DMS camera, determines headlamps of a trailing vehicle (behind the equipped vehicle and traveling in the same direction as the equipped vehicle and traveling in the same traffic lane or in an adjacent traffic lane) to determine glare light at the mirror reflective element. The processing of image data captured by the DMS camera is adjusted to accommodate the degree of dimming of the mirror reflective element. For example, the system knows how much the mirror reflective element is dimmed (responsive to the determined glare light intensity and location) and can accommodate for the mirror dimming level when processing captured image data to determine presence and intensity of light sources/headlamps rearward of the vehicle. The intelligent/automatic mirror dimming functions may utilize aspects of the systems described in U.S. Publication Nos. US-2024-0064274; US-2019-0258131 and/or US-2019-0047475, which are hereby incorporated herein by reference in their entireties.

Optionally, the system, via processing of image data captured by the DMS camera viewing the driver's eyes, may determine glare light by detecting reflection of glare light off of the driver's eyes (or off of eyeglasses if worn by the driver). For example, glare light emanating from a rearward approaching vehicle behind the equipped vehicle may reflect off the mirror reflector of the mirror reflective element of the interior rearview mirror assembly and reflect toward the driver's eyes (or eyeglasses) and reflect off the driver's eyes (or eyeglasses). The system may detect the glare light reflections at the driver's eyes (or eyeglasses) and may control dimming of the mirror reflective element and/or control of the video display screen accordingly. The system thus may determine glare light emanating from rearward of the vehicle by processing image data captured by the driver monitoring camera, particularly by processing a portion of the captured image data that is representative of the driver's eyes, thereby avoiding having to process larger amounts of image data representative of a view rearward of the vehicle.

The ECU may be disposed at or within the mirror head (along with the camera and light emitter and video display screen). Optionally, the ECU may be disposed remote from the mirror head and from the DMS/OMS camera, whereby image data captured by the DMS camera (and/or another camera, such as a forward-viewing camera disposed at the in-cabin side of the windshield and viewing through the windshield) may be transferred to the ECU (and optionally control signals and/or power may be transferred to the camera or cameras) via one or more coaxial cables, such as by utilizing aspects of the systems described in U.S. Pat. Nos. 10,567,705 and/or 10,057,544, which are hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular driver monitoring system, the vehicular driver monitoring system comprising:
an interior rearview mirror assembly comprising a mirror head adjustable about a mounting structure, wherein the mounting structure is configured to mount the interior rearview mirror assembly at an interior portion of an interior cabin of a vehicle;
wherein the mirror head accommodates a mirror reflective element and a video display screen;
wherein, with the interior rearview mirror assembly mounted at the interior portion of the interior cabin of the vehicle, the video display screen is electrically operable to display video images for viewing by a driver of the vehicle;
a driver monitoring camera accommodated by the mirror head, wherein the driver monitoring camera moves together and in tandem with the mirror head when, with the interior rearview mirror assembly mounted at the interior portion of the interior cabin of the vehicle, the mirror head is adjusted about the mounting structure to set a rearward view for the driver of the vehicle;
wherein, with the interior rearview mirror assembly mounted at the interior portion of the interior cabin of the vehicle, and with the mirror head adjusted about the mounting structure to set the rearward view for the driver of the vehicle, the driver monitoring camera views at least a driver's head region of the interior cabin of the vehicle;
wherein the driver monitoring camera is operable to capture image data;
an electronic control unit (ECU);
wherein image data captured by the driver monitoring camera is transferred to the ECU;
wherein the ECU comprises electronic circuitry and associated software, and wherein the electronic circuitry of the ECU comprises an image processor operable to process image data captured by the driver monitoring camera and transferred to the ECU;
wherein, based at least in part on processing at the ECU of image data captured by the driver monitoring camera, the vehicular driver monitoring system determines a gaze direction of the driver of the vehicle;
wherein, based at least in part on determination that the gaze direction of the driver of the vehicle is directed toward the mirror head of the interior rearview mirror assembly, the video display screen is electrically operated to display video images at a first brightness; and
wherein, based at least in part on determination that the gaze direction of the driver of the vehicle is not directed toward the mirror head of the interior rearview mirror assembly, the video display screen is electrically operated to display video images at a second brightness that is less than the first brightness.

2. The vehicular driver monitoring system of claim 1, wherein a second display screen is disposed within the interior cabin of the vehicle remote from the interior rearview mirror assembly, and wherein, based at least in part on determination that the gaze direction of the driver of the vehicle is directed toward the second display screen, the second display screen is electrically operated to display images at a first brightness, and wherein, based at least in part on determination that the gaze direction is not directed toward the second display screen, the second display screen is electrically operated to display images at a second brightness that is less than the first brightness.

3. The vehicular driver monitoring system of claim 2, wherein the second display screen comprises at least one selected from the group consisting of (i) an infotainment display screen and (ii) a gauge cluster display screen.

4. The vehicular driver monitoring system of claim 2, wherein the video display screen is electrically operated to display video images at the second brightness based at least in part on the second video display screen being electrically operated to display images at the first brightness.

5. The vehicular driver monitoring system of claim 1, wherein brightness of the displayed video images is adjustable based at least in part on a determined level of ambient light level within the interior cabin of the vehicle.

6. The vehicular driver monitoring system of claim 5, wherein, as the video display screen electrically operates to display video images at the first brightness, brightness of the displayed video images is adjusted based at least in part on the determined level of ambient light according to a full-power profile of operation, and wherein a greatest brightness along the full-power profile of operation is greater than the second brightness.

7. The vehicular driver monitoring system of claim 5, wherein, as the video display screen electrically operates to display video images at the second brightness, brightness of the displayed video images is adjusted based at least in part on the determined level of ambient light according to a reduced-power profile of operation, and wherein a greatest brightness along the reduced-power profile of operation is less than the first brightness.

8. The vehicular driver monitoring system of claim 1, wherein, based at least in part on determination that a thermal load at the interior rearview mirror assembly is greater than a threshold thermal load, the video display screen is electrically operated to display video images at the second brightness.

9. The vehicular driver monitoring system of claim 1, wherein brightness of the video display screen is adjusted based at least in part on a thermal load at the interior rearview mirror assembly.

10. The vehicular driver monitoring system of claim 9, wherein, based at least in part on determination that the gaze direction of the driver of the vehicle is not directed toward the mirror head of the interior rearview mirror assembly, and based at least in part on determination that the thermal load at the interior rearview mirror assembly is less than a threshold thermal load, the video display screen is electrically operated to display video images at the first brightness.

11. The vehicular driver monitoring system of claim 1, wherein, based at least in part on processing at the ECU of image data captured by the driver monitoring camera, the vehicular driver monitoring system determines light emanating from a trailing vehicle that is rearward of the vehicle by detecting light reflecting off one selected from the group consisting of (i) the eyes of the driver of the vehicle and (ii) eyeglasses worn by the driver of the vehicle.

12. The vehicular driver monitoring system of claim 1, further comprising a light emitter accommodated by the mirror head and operable to emit light to illuminate the head of the driver of the vehicle.

13. The vehicular driver monitoring system of claim 12, wherein, based at least in part on processing at the ECU of image data captured by the driver monitoring camera, the vehicular driver monitoring system determines orientation of a sun visor at the driver side of the vehicle and determines that the sun visor at least partially blocks light emitted by the light emitter from illuminating the head of the driver of the vehicle.

14. The vehicular driver monitoring system of claim 1, wherein the video display screen is accommodated in the mirror head behind the mirror reflective element, and wherein, with the interior rearview mirror assembly mounted at the interior portion of the interior cabin of the vehicle, the video display screen is electrically operable to display video images for viewing by the driver of the vehicle through the mirror reflective element.

15. The vehicular driver monitoring system of claim 14, wherein the interior rearview mirror assembly comprises a dual-mode mirror, and wherein, when the dual-mode mirror operates in a reflection mode, the driver of the vehicle, when viewing the mirror reflective element, views reflections off a mirror reflector of the mirror reflective element, and wherein, when the dual-mode mirror operates in a video display mode, the driver of the vehicle, when viewing the mirror reflective element, views video images displayed by the video display screen.

16. A vehicular driver monitoring system, the vehicular driver monitoring system comprising:
an interior rearview mirror assembly comprising a mirror head adjustable about a mounting structure, wherein the mounting structure is configured to mount the interior rearview mirror assembly at an interior portion of an interior cabin of a vehicle;
wherein the mirror head accommodates a variable reflectance mirror reflective element;
a driver monitoring camera accommodated by the mirror head, wherein the driver monitoring camera moves together and in tandem with the mirror head when, with the interior rearview mirror assembly mounted at the interior portion of the interior cabin of the vehicle, the mirror head is adjusted about the mounting structure to set a rearward view for a driver of the vehicle, and wherein the driver monitoring camera views through the variable reflectance mirror reflective element;
wherein, with the interior rearview mirror assembly mounted at the interior portion of the interior cabin of the vehicle, and with the mirror head adjusted about the mounting structure to set the rearward view for the driver of the vehicle, the driver monitoring camera views at least a driver's head region of the interior cabin of the vehicle;
wherein the driver monitoring camera is operable to capture image data;
an electronic control unit (ECU);
wherein image data captured by the driver monitoring camera is transferred to the ECU;
wherein the ECU comprises electronic circuitry and associated software, and wherein the electronic circuitry of the ECU comprises an image processor operable to process image data captured by the driver monitoring camera and transferred to the ECU;
wherein, based at least in part on processing at the ECU of image data captured by the driver monitoring camera, the vehicular driver monitoring system determines a gaze direction of the driver of the vehicle; and
wherein, with a propulsion system of the vehicle in park, and based at least in part on determination that the gaze direction of the driver of the vehicle is directed toward the mirror head of the interior rearview mirror assembly, a light source at the interior cabin of the vehicle is electrically operated to emit light and illuminate at least a portion of the interior cabin of the vehicle.

17. The vehicular driver monitoring system of claim 16, wherein the light source is disposed at the interior cabin of the vehicle remote from the interior rearview mirror assembly.

18. The vehicular driver monitoring system of claim 16, wherein the light source is disposed at the interior rearview mirror assembly.

19. The vehicular driver monitoring system of claim 18, wherein the light source, when electrically operated to emit light, emits light that passes through the variable reflectance mirror reflective element.

20. The vehicular driver monitoring system of claim 19, wherein the light source comprises a ring light that at least partially circumscribes the variable reflectance mirror reflective element.

21. The vehicular driver monitoring system of claim 16, wherein the light source is electrically operated to emit light further based at least in part on determination that an ambient light level at the vehicle is below a threshold level of light.

22. The vehicular driver monitoring system of claim 21, wherein the ambient light level at the vehicle is determined based at least in part on processing of sensor data captured by an ambient light sensor of the vehicle.

23. The vehicular driver monitoring system of claim 16, wherein, with the propulsion system in park, and based at least in part on determination that a distance between the driver of the vehicle and the interior rearview mirror assembly is below a threshold distance, the light source is electrically operated.

24. The vehicular driver monitoring system of claim 23, wherein the distance between the driver of the vehicle and the interior rearview mirror assembly is determined based at least in part on processing at the ECU of image data captured by the driver monitoring camera.

25. The vehicular driver monitoring system of claim 16, wherein, with the propulsion system of the vehicle in a driving setting, and based at least in part on determination that the gaze direction of the driver of the vehicle is directed toward a display screen of the vehicle, the vehicular driver monitoring system adjusts operation of the display screen to adjust images displayed at the display screen.

26. The vehicular driver monitoring system of claim 25, wherein the vehicular driver monitoring system adjusts operation of the display screen between (i) a sleep mode, where the display screen is not being operated to display images and (ii) an operational mode, where the display screen is being operated to display images for viewing by the driver of the vehicle.

27. The vehicular driver monitoring system of claim 26, wherein, with the display screen operating in the sleep mode, and based at least in part on determination that the gaze direction of the driver of the vehicle is directed toward the display screen, the vehicular driver monitoring system adjusts operation of the display screen from the sleep mode to the operational mode.

28. The vehicular driver monitoring system of claim 26, wherein, with the display screen operating in the operational mode, and based at least in part on determination that the gaze direction of the driver of the vehicle is directed toward the display screen for longer than a threshold period of time, the vehicular driver monitoring system adjusts operation of the display screen from the operational mode to the sleep mode.

29. The vehicular driver monitoring system of claim 25, wherein the display screen is disposed at the interior rearview mirror assembly and wherein the display screen, when operated to display images, displays images that are viewable through the variable reflectance mirror reflective element.

30. The vehicular driver monitoring system of claim 25, wherein the display screen is disposed at a center console of the vehicle.

31. A vehicular driver monitoring system, the vehicular driver monitoring system comprising:
an interior rearview mirror assembly comprising a mirror head adjustable about a mounting structure, wherein the mounting structure is configured to mount the interior rearview mirror assembly at an interior portion of an interior cabin of a vehicle;
wherein the mirror head accommodates a mirror reflective element and a video display screen;
wherein the video display screen is accommodated in the mirror head behind the mirror reflective element;
wherein, with the interior rearview mirror assembly mounted at the interior portion of the interior cabin of the vehicle, the video display screen is electrically operable to display video images for viewing by a driver of the vehicle through the mirror reflective element;
wherein the interior rearview mirror assembly comprises a dual-mode mirror, and wherein, when the dual-mode mirror operates in a reflection mode, the driver of the vehicle, when viewing the mirror reflective element, views reflections off a mirror reflector of the mirror reflective element, and wherein, when the dual-mode mirror operates in a video display mode, the driver of the vehicle, when viewing the mirror reflective element, views video images displayed by the video display screen;
wherein brightness of the displayed video images is adjustable based at least in part on a determined level of ambient light level within the interior cabin of the vehicle;
a driver monitoring camera accommodated by the mirror head, wherein the driver monitoring camera moves together and in tandem with the mirror head when, with the interior rearview mirror assembly mounted at the interior portion of the interior cabin of the vehicle, the mirror head is adjusted about the mounting structure to set a rearward view for the driver of the vehicle;
wherein, with the interior rearview mirror assembly mounted at the interior portion of the interior cabin of the vehicle, and with the mirror head adjusted about the mounting structure to set the rearward view for the driver of the vehicle, the driver monitoring camera views at least a driver's head region of the interior cabin of the vehicle;
wherein the driver monitoring camera is operable to capture image data;
an electronic control unit (ECU);
wherein image data captured by the driver monitoring camera is transferred to the ECU;
wherein the ECU comprises electronic circuitry and associated software, and wherein the electronic circuitry of the ECU comprises an image processor operable to process image data captured by the driver monitoring camera and transferred to the ECU;
wherein, based at least in part on processing at the ECU of image data captured by the driver monitoring camera, the vehicular driver monitoring system determines a gaze direction of the driver of the vehicle;
wherein, based at least in part on determination that the gaze direction of the driver of the vehicle is directed toward the mirror head of the interior rearview mirror assembly, the video display screen is electrically operated to display video images at a first brightness; and
wherein, based at least in part on determination that the gaze direction of the driver of the vehicle is not directed toward the mirror head of the interior rearview mirror assembly, the video display screen is electrically operated to display video images at a second brightness that is less than the first brightness.

32. The vehicular driver monitoring system of claim 31, wherein a second display screen is disposed within the interior cabin of the vehicle remote from the interior rearview mirror assembly, and wherein, based at least in part on determination that the gaze direction of the driver of the vehicle is directed toward the second display screen, the second display screen is electrically operated to display images at a first brightness, and wherein, based at least in part on determination that the gaze direction is not directed toward the second display screen, the second display screen is electrically operated to display images at a second brightness that is less than the first brightness.

33. The vehicular driver monitoring system of claim 32, wherein the video display screen is electrically operated to display video images at the second brightness based at least in part on the second video display screen being electrically operated to display images at the first brightness.

34. The vehicular driver monitoring system of claim 31, wherein, as the video display screen electrically operates to display video images at the first brightness, brightness of the displayed video images is adjusted based at least in part on the determined level of ambient light according to a full-power profile of operation, and wherein a greatest brightness along the full-power profile of operation is greater than the second brightness.

35. The vehicular driver monitoring system of claim 31, wherein, as the video display screen electrically operates to display video images at the second brightness, brightness of the displayed video images is adjusted based at least in part on the determined level of ambient light according to a reduced-power profile of operation, and wherein a greatest brightness along the reduced-power profile of operation is less than the first brightness.
